(19) United States
(12) Patent Application Publication
(10) Pub. No.: US 2018/0326703 A1
(43) Pub. Date: Nov. 15, 2018

(54) METAL-PLASTIC COMPOSITE AND METHOD FOR PRODUCING SUCH A COMPOSITE

(71) Applicant: Salzgitter Flachstahl GmbH, 38239 Slazgitter (DE)

(72) Inventors: ANDREAS WEDEMEIER, Braunschweig (DE); BENJAMIN POLLER, Hannover (DE)

(73) Assignee: Salzgitter Flachstahl GmbH, 38239 Slazgitter (DE)

(21) Appl. No.: 15/772,406

(22) PCT Filed: Oct. 20, 2016
(86) PCT No.: PCT/DE2016/100489

§ 371 Date: Apr. 30, 2018

(30) Foreign Application Priority Data
Oct. 30, 2015 (DE) 10 2015 118 597.0

(51) Int. Cl. B32B 15/088; B32B 15/082; C23C 28/00; B32B 37/15

(52) U.S. Cl. CPC B32B 15/088; B32B 15/082; C23C 28/34; C23C 22/07; B32B 37/153; B32B 2398/20; C23C 28/3225

(57) ABSTRACT

In a metal-plastic composite, in which the metallic component is connected by a material joint to a thermoplastic applied thereto, a material bond between the metallic component and the plastic is realized by applying on the metallic component on a surface area that comes into contact with the thermoplastic a corrosion-protective coating made of phosphatization.

### DESCRIPTION

The invention relates to a metal/plastic composite and a method for producing such a composite.

Such composites are used increasingly as hybrid components, for example in the automotive industry for various applications as a lightweight material to thereby reduce the vehicle weight and thus CO₂ emission.

In these composites, a thermoplastic layer is applied, for example by back injection molding or extrusion, on a cold formed or hot formed carrier of metal, which, for example, may be made from a monolithic steel sheet or from a sandwich plate with two steel cover sheets and interposed plastic layer. This plastic layer serves to reinforce or stiffen the structure in terms of mechanical stress during operation, as it significantly increases the torsional and crash stiffness of the component. Examples of plastics include polyethylene (PE), polypropylene (PP), polyetheretherketone (PEEK), polyphenylene sulfide (PPS), polyvinyl chloride (PVC) or polyamides such as polyamide 6 (PA6), polyamide 6.6 (PA6.6) or polyphthalamide (PPA) with or without fiber reinforcement.

However, bonding of the polymer to the metallic material is difficult. Material shrinkage of the polymer and different expansion coefficients of the materials used lead to a detachment between metal component and polymer structure, so that the desired mechanical properties of the composite cannot be achieved. Therefore, without pretreatment of the metal surface, the material bond of the sprayed-on plastic onto the metallic carrier is low due to different chemical and physical properties of both materials.

DE 10 2008 040 967 A1 discloses various possibilities to achieve a bond between steel and plastic. Examples include mechanical clamping by undercuts in the carrier, adhesives as adhesion promoter for a material bond, and surface treatment of plastic through plasma treatment.

The mentioned possibilities for improving adhesion between plastic and steel are either very complex and expensive or in the case of purely mechanical clamping fails to achieve the hoped-for improvement of the mechanical properties of the composite.

Object of the invention is to provide a metal/plastic composite which can be produced more cost-effectively compared to known composites while maintaining at least same good mechanical properties. Furthermore, a method for the production of such a composite shall be specified.

This object is attained with respect to the composite by the features of claim 1 and with respect to the method by the features of claim 9. Advantageous refinements are subject matter of sub-claims.

The teaching of the invention includes a metal/plastic composite, in which the metallic component is connected by a material joint with a thermoplastic applied thereto and is characterized in that a material bond between the metallic component and the plastic is established on the surface areas coming into contact with the plastic by a corrosion-protective coating which is made by phosphatization.

Although phosphatization as a corrosion-protective substrate for a subsequent painting already results in a considerable improvement in the adhesion of the plastic on the phosphated metal surface, a further improvement of the material bond in accordance with an advantageous refinement of the invention is realized by applying a cathodic dip painting (also called CDP coating) onto the phosphatization before applying the plastic. The cathodic dip painting is then baked in according to the invention either together with the plastic applied thereto or before applying the plastic at a temperature of 160° C. to 220° C., advantageously between 160° C. and 180° C.

In the course of extensive experiments, it was surprisingly found that, unlike the adhesion promoters or adhesives, commonly used for metal/plastic composites, phosphatization as used in particular in the automotive industry is eminently suited to ensure a superior material bond between the carrier of metal and the plastic to be applied. This saves an additional manufacturing step for the application of an adhesive promoter or adhesive and costs for the adhesive promoter or the adhesive itself. Application of a cathodic dip painting (CDP) on the phosphate layer for priming or pre-coating of vehicle components to be painted further improves an already very good adhesion upon the phosphated metal surface.

The metallic component is advantageously produced from a cold formed or hot formed steel sheet blank, which is subsequently cleaned and then phosphated and which subsequently optionally receives a cathodic dip painting. The cathodic dip painting is baked in either with the plastic applied to it or prior to application of the plastic. Examples of a steel sheet for the production of the metallic component include a monolithic sheet or a metal/plastic/metal sandwich sheet.

The application of the invention is conceivable in principle for components of most different metallic materials, in particular however for steel, aluminum or magnesium.

Correspondingly, the method according to the invention for the production of a metal/plastic composite includes a metallic component, which is connected by a material joint to a thermoplastic applied thereto and which is characterized in that a material bond between the metallic component and the plastic is realized by applying a corrosion-protective coating in the form of a phosphatization, prior to the application of the plastic, onto the surface areas that come into contact with the plastic

In accordance with an advantageous refinement of the invention, a cathodic dip painting shall be applied upon the phosphatization for further improvement of the adhesion of the plastic, and the cathodic dip painting is baked in either together with the plastic subsequently applied to the CDP coating or prior to application of the plastic at a temperature of 160° C. to 220° C., advantageously between 160° C. and 180° C.

Cathodic dip painting is an electrochemical process for the application of water-dilutable paints (electro-deposition paints) on electrically conductive substrates. The electrically conductive substrate, also called workpiece or component, is dipped in a paint bath, an electric direct current field is applied between the workpiece and a counter electrode, the ionized paint discharges and coagulates on the workpiece, so that the coating of the workpiece is being built up. The deposited paint film often has a solids content of 80 to 90% and is no longer water-dilutable, so that the adhering bath liquid can be washed off with water. The paint film is then cured by baking.

Examples of plastic for use in accordance with the invention may include polyethylene (PE), polypropylene (PP), polyetheretherketone (PEEK), polyphenylene sulfide (PPS), polyvinyl chloride (PVC) or polyamides such as polyamide 6 (PA6), polyamide 6.6 (PA6.6) or polyphthalamides (PPA) with or without fiber reinforcement, which are applied as extruded, foamed or sprayed-on layer, as a film or tape onto the metallic component.

According to the invention, provision is further made advantageously for a corrosion-protective metallic coat upon the metallic component prior to the application of the phosphatization and the optional CDP coating. The metallic coat may be made of zinc or predominantly of zinc and may be formed as a hot-dip coat or as an electrolytically deposited coat on the metallic component.

Compared to the known prior art, the metal/plastic composite according to the invention does not require separately applied adhesion promoters or adhesives in order to ensure sufficient adhesion between metallic component and thermoplastic.

The innovative idea in an automobile-typical pre-treatment of a body for a paint job resides in that the plastic to be applied, for example a thermoplastic, is applied preferably with similar processing temperature as the temperature in the baking oven after application of the cathodic dip painting and to melt it as the CDP coating is baked in to thereby realize a material bond of the plastic to CDP coating.

As an alternative, prior to application of the plastic, the CDP coating is baked in at a temperature of 160° C. to 220° C., advantageously between 160° C. and 180° C., and then the thermoplastic is applied thereto. The advantage of the latter procedure is that in this case also plastics with higher processing temperatures than the baking temperature of the CDP coating can be applied, such as polyamide PA6 for example.

In both process variants, phosphatization required anyway in the case of vehicle bodies, and the CDP coating applied thereto are used simultaneously as adhesion promoter between the metallic component and the plastic applied thereon.

The advantages result from the fact that a phosphatization and a CDP coating are generally applied in the automotive industry. The application of a necessary adhesion promoter, however, is an additional process step, which can be eliminated by the use of the CDP coating as adhesion-promoting medium. Thus, the need for an additional necessary process stage can be dispensed with. In addition, there is no need for further adhesion promoters, i.e.
no additional material costs
no further solvents.

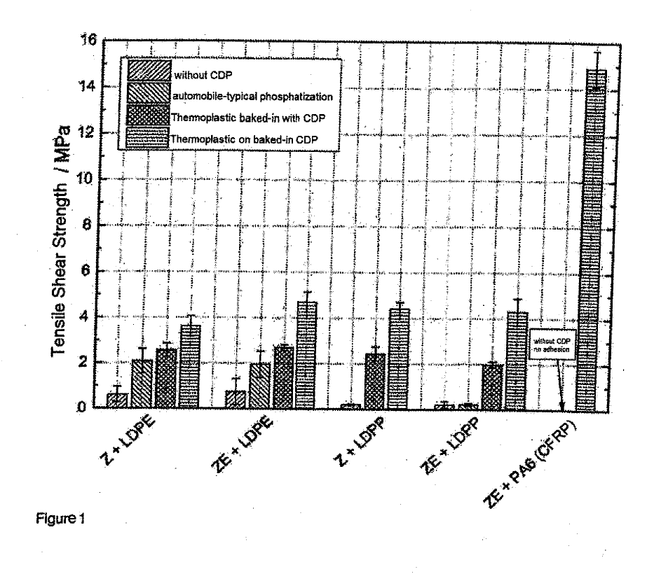

For experiments, various thermoplastics such as LDPE, LDPP and PA6 (CFRP) were applied to an electrolytically galvanized (ZE) or hot dip coated (Z) steel sheet. The polyamide 6 was reinforced with 60% carbon fibers. Subsequently, the tensile shear strength was determined in accordance with DIN EN 1465 with and without applied phosphatization or CDP coating including phosphatization. Examined according to FIG. 1 were the variants “bare steel surface” (bar “without CDP”), “automobile-typical phosphated” (bar “automobile-typical phosphatization”) and the two variants in which the thermoplastic is applied before the CDP is being baked in (bar “thermoplastic baked-in with CDP”), or the thermoplastic is applied to the already baked-in CDP coating (bar “thermoplastic on baked-in CDP”).

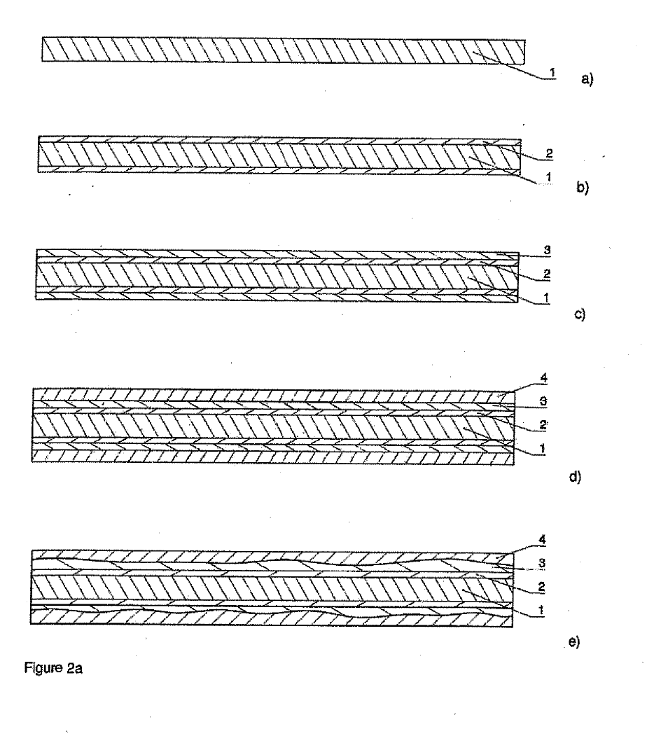

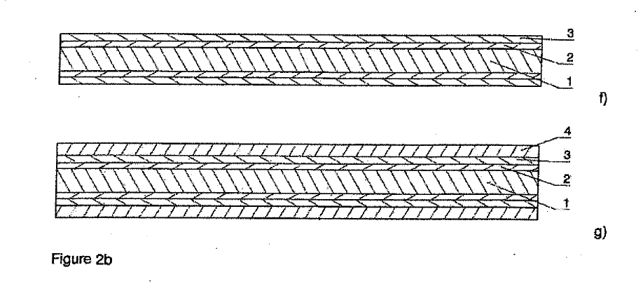

As the test results according to FIG. 1 show for the tensile shear strength on sheet metal samples with plastic applied thereto (cf. FIGS. 2a and 2b), a clear improvement in adhesion can be realized in comparison to a bare steel surface (bar “without CDP”) already by phosphatization as a pretreatment (bar “automobile-typical phosphatization”) for a paint structure. A CDP coating is able to even further significantly increase the adhesion in the steel/plastic composite, with the best results being achieved when the thermoplastic is applied to the already baked-in CDP coating.

While in the case of a bare surface (bar “without CDP”) of the steel sheet virtually no adhesion to the plastic was achieved, in particular the application of the plastic on an already baked-in CDP coating results in a very significant improvement of the adhesion. As expected, best adhesion values on the baked-in CDP coating are achieved with polyamide PA6 with 60% carbon fibers.

The basic structure of both examined process variants, in which the thermoplastic is applied prior to baking-in of the CDP and in which the thermoplastic is applied to the already baked-in CDP coating, is shown in FIGS. 2a and 2b with reference to a metal/plastic composite sheet. The various processing conditions are marked with the letters a) to g). A corresponding structure and the sequences of the necessary operating steps are established analogously for the production of metal/plastic composites.

According to the first process variant (“thermoplastic baked-in with CDP”) according to FIG. 2a, a steel sheet 1 (state a) is first provided with a phosphatization 2 (state b), to which a CDP coating 3 is applied (state c). Subsequently, the thermoplastic 4 is applied as a film, extrusion or sprayed layer (state d) on the CDP coating 3. Finally, the CDP coating is baked in or the thermoplastic 4 is melted (state e).

FIG. 2b shows the alternative process variant (“thermoplastic on baked-in CDP”), in which the steel sheet 1 firstly receives a phosphatization 2 and CDP coating 3, which is subsequently baked in (state f). The thermoplastic 4 is then applied in the form of a film, extrusion or sprayed coating on the baked CDP coating 3 (state g). In both process variants a material joint is realized between steel sheet and thermoplastic with excellent adhesion.

1.-13. (canceled)

14. A metal-plastic composite, comprising:
a metallic component;
a thermoplastic; and
a corrosion-protective phosphatization coating applied on a surface area of the metallic component which surface area comes into contact with the thermoplastic for effecting a material bond between the metallic component and the thermoplastic.

15. The composite of claim 14, further comprising a cathodic dip painting applied on the phosphatization coating to further improve the material bond of the thermoplastic on the metallic component, said cathodic dip painting being baked in either together with the thermoplastic or prior to application of the thermoplastic at a temperature of 160° C. to 220° C.

16. The composite of claim 14, further comprising a cathodic dip painting applied on the phosphatization coating to further improve the material bond of the thermoplastic on the metallic component, said cathodic dip painting being baked in either together with the thermoplastic or prior to application of the thermoplastic at a temperature between 160° C. and 180° C.

17. The composite of claim 14, wherein that the metallic component is made of steel, aluminum or magnesium.

18. The composite of claim 14, wherein the thermoplastic is made of polyetheretherketone, polyphenylene sulphide, polyvinyl chloride, polyethylene, polypropylene or polyamides.

19. The composite of claim 14, wherein the thermoplastic is applied as an extruded, foamed or sprayed-on layer or as a film or tape upon the metallic component.

20. The composite of claim 14, further comprising with a corrosion-protective metallic coat applied on the metallic component.

21. The composite of claim 20, wherein the metallic coat is made of zinc or predominantly of zinc.

22. The composite of claim 20, wherein the metallic coat is a hot-dip coat or electrolytically deposited coat.

23. A method for the production of a composite of a metallic component and a thermoplastic, said method comprising applying a corrosion-protective phosphatization coating on a surface area of the metallic component, which surface area comes into contact with the thermoplastic, prior to an application of the thermoplastic onto the metallic component for effecting a material bond between the metallic component and the thermoplastic.

24. The method of claim 23, further comprising applying a cathodic dip painting on the metallic component after application of the phosphatization coating, and baking the cathodic dip painting either together with the thermoplastic or before applying the thermoplastic at a temperature of 160° C. to 220° C.

25. The method of claim 23, further comprising applying a cathodic dip painting on the metallic component after application of the phosphatization coating, and baking the cathodic dip painting either together with the thermoplastic or before applying the thermoplastic at a temperature between 160° C. and 180° C.

26. The method of claim 23, wherein the metallic component is produced from a cold formed or hot formed sheet metal blank of steel, aluminum or magnesium.

27. The method of claim 26, wherein the sheet metal blank is produced from a monolithic metal strip provided with a corrosion-protective metallic coat or a metal-plastic-metal sandwich sheet.

28. The method of claim 27, further comprising coating the metal strip with zinc or with a zinc alloy electrolytically or by hot dipping.
